(19) United States
(12) Patent Application Publication
(10) Pub. No.: US 2021/0020179 A1
(43) Pub. Date: Jan. 21, 2021

(54) INFORMATION PROCESSING APPARATUS, INFORMATION PROCESSING SYSTEM, INFORMATION PROCESSING METHOD, AND PROGRAM

(71) Applicant: SONY CORPORATION, TOKYO (JP)

(72) Inventor: Keiichi YAMADA, TOKYO (JP)

(21) Appl. No.: 16/979,766

(22) PCT Filed: Jan. 29, 2019
(86) PCT No.: PCT/JP2019/003032

§ 371 Date: Sep. 10, 2020

(30) Foreign Application Priority Data
Mar. 19, 2018 (JP) 2018-050772

(51) Int. Cl. G10L 15/25; G10L 15/04; G10L 15/28

(52) U.S. Cl. CPC G10L 15/25; G10L 15/28; G10L 15/04

(57) ABSTRACT

Provided are an apparatus and a method that implement a highly accurate voice recognition process based on sound source direction and voice section analysis to which an image and a voice are applied. A voice processing unit that executes a voice recognition process on a user utterance is provided, and the voice processing unit includes: a sound source direction/voice section designation unit that designates a sound source direction and a voice section of the user utterance; and a voice recognition unit that executes a voice recognition process targeting voice data in the sound source direction and the voice section designated by the sound source direction/voice section designation unit. The sound source direction/voice section designation unit and the voice recognition unit execute a designation process for the sound source direction and the voice section and the voice recognition process on the user utterance on condition that it is determined that a user who has executed the user utterance is looking at a predetermined specified area.

### TECHNICAL FIELD

The present disclosure relates to an information processing apparatus, an information processing system, an information processing method, and a program. In more detail, the present disclosure relates to an information processing apparatus, an information processing system, an information processing method, and a program that perform voice recognition for a user utterance and perform a variety of processes and responses based on the recognition result.

### BACKGROUND ART

Recently, the use of a voice recognition apparatus that performs voice recognition for a user utterance and performs a variety of processes and responses based on the recognition result is increasing.

In this voice recognition apparatus, a user utterance input via a microphone is analyzed and a process according to the analysis result is performed.

For example, in a case where a user utters “What will the weather be like tomorrow?”, the weather information is acquired from a weather information providing server, and a system response based on the acquired information is generated such that the generated response is output from a speaker. Specifically, for example,

System utterance=“Tomorrow's weather is sunny. However, there may be a thunderstorm in the evening”

The voice recognition apparatus outputs such a system utterance.

In a general voice recognition apparatus, it is difficult to correctly perform recognition in a case where the noise level of the ambient environmental sounds or the like is relatively high.

By performing noise reduction using a beamforming process that selects only sound in a specified direction, or an echo cancellation process that identifies reverberant sound and decreases reverberant sound, or the like to achieve noise reduction, and selectively inputting the voice of a user utterance to perform voice recognition, it becomes possible to mitigate the deterioration of the recognition performance to some extent.

Note that, for example, Patent Document 1 (Japanese Patent Application Laid-Open No. 2014-153663) is cited as prior art that discloses a configuration that reduces the influence of noise and enables highly accurate voice recognition.

However, even if such processes are performed, precise voice recognition is sometimes not possible in a case where the influence of noise is larger.

Furthermore, some voice recognition apparatuses have a configuration in which voice recognition is not performed for all user utterances, and voice recognition is started in response to the detection of a predetermined “activation word” such as a call to the apparatus.

That is, when the user inputs a voice, the user first utters a predetermined “activation word”.

The voice recognition apparatus transitions to the voice input standby state in response to the detection of the input of this “activation word”. After this state transition, the voice recognition apparatus starts voice recognition for the user utterance.

However, in such an apparatus, the user needs to speak the activation word beforehand, besides an utterance corresponding to the original user request. The voice recognition apparatus starts voice recognition after the activation word is input, but once a certain period of time has elapsed thereafter, the voice recognition function is turned off (sleep mode) again. Therefore, every time the voice recognition function is turned off, the user needs to speak the activation word. There is also a difficulty in that the voice recognition function cannot be used in a case where the user does not know or forgets the activation word.

### CITATION LIST

### Patent Document

Patent Document 1: Japanese Patent Application Laid-Open No. 2014-153663
Patent Document 2: Japanese Patent Application Laid-Open No. 2012-003326

### SUMMARY OF THE INVENTION

### Problems to be Solved by the Invention

The present case has been made in view of, for example, the above difficulties, and an object of the present case is to provide an information processing apparatus, an information processing system, an information processing method, and a program that precisely discriminate an utterance of a user as an object even in a noisy environment, and implement highly accurate voice recognition by executing image analysis together with voice analysis.

### Solutions to Problems

A first aspect of the present disclosure is

an information processing apparatus including a voice processing unit that executes a voice recognition process on a user utterance, in which

the voice processing unit includes: a sound source direction/voice section designation unit that designates a sound source direction and a voice section of the user utterance; and

a voice recognition unit that executes a voice recognition process targeting voice data in the sound source direction and the voice section designated by the sound source direction/voice section designation unit, and

the sound source direction/voice section designation unit

executes a designation process for the sound source direction and the voice section on the user utterance on condition that it is determined that a user who has executed the user utterance is looking at a predetermined specified area.

Moreover, a second aspect of the present disclosure is

an information processing system including a user terminal and a data processing server, in which

the user terminal includes:

a voice input unit that inputs a user utterance; and

an image input unit that inputs a user image,

the data processing server includes

a voice processing unit that executes a voice recognition process on the user utterance received from the user terminal,

the voice processing unit includes: a sound source direction/voice section designation unit that designates a sound source direction and a voice section of the user utterance; and

a voice recognition unit that executes a voice recognition process targeting voice data in the sound source direction and the voice section designated by the sound source direction/voice section designation unit, and

the sound source direction/voice section designation unit

executes a designation process for the sound source direction and the voice section on the user utterance on condition that it is determined that a user who has executed the user utterance is looking at a predetermined specified area.

Moreover, a third aspect of the present disclosure is

an information processing method executed in an information processing apparatus, the information processing method including:

executing, by a sound source direction/voice section designation unit, a sound source direction/voice section designation step of executing a process of designating a sound source direction and a voice section of a user utterance; and

executing, by a voice recognition unit, a voice recognition step of executing a voice recognition process targeting voice data in the sound source direction and the voice section designated by the sound source direction/voice section designation unit, in which

the sound source direction/voice section designation step and the voice recognition step include

steps executed on condition that it is determined that a user who has executed the user utterance is looking at a predetermined specified area.

Moreover, a fourth aspect of the present disclosure is

an information processing method executed in an information processing system including a user terminal and a data processing server, the information processing method including:

executing, in the user terminal:

a voice input process of inputting a user utterance; and

an image input process of inputting a user image; and

executing, in the data processing server:

a sound source direction/voice section designation step of executing, by a sound source direction/voice section designation unit, a process of designating a sound source direction and a voice section of the user utterance; and

a voice recognition step of executing, by a voice recognition unit, a voice recognition process targeting voice data in the sound source direction and the voice section designated by the sound source direction/voice section designation unit, in which

the data processing server

executes the sound source direction/voice section designation step and the voice recognition step on condition that it is determined that a user who has executed the user utterance is looking at a predetermined specified area.

Moreover, a fifth aspect of the present disclosure is

a program that causes an information process to be executed in an information processing apparatus, the program causing:

a sound source direction/voice section designation unit to execute a sound source direction/voice section designation step of executing a process of designating a sound source direction and a voice section of a user utterance; and

a voice recognition unit to execute a voice recognition step of executing a voice recognition process targeting voice data in the sound source direction and the voice section designated by the sound source direction/voice section designation unit,

the program causing the sound source direction/voice section designation step and the voice recognition step

to be executed on condition that it is determined that a user who has executed the user utterance is looking at a predetermined specified area.

Note that the programs of the present disclosure are programs that can be provided by a storage medium or a communication medium configured to provide a program in a computer readable format, for example, to an information processing apparatus or a computer system capable of executing a variety of program codes. By providing such programs in a computer readable format, processes according to the programs are implemented on the information processing apparatus or the computer system.

Still another object, feature, and advantage of the present disclosure will be made clear through more detailed description based on the embodiments of the present invention mentioned below and the accompanying drawings. Note that, in the present description, the term “system” refers to a logical group configuration of a plurality of apparatuses and is not limited to a system in which apparatuses having respective configurations are accommodated in the same housing.

### Effects of the Invention

According to a configuration of an embodiment of the present disclosure, a highly accurate voice recognition process based on sound source direction and voice section analysis to which an image and a voice are applied is implemented.

Specifically, for example, a voice processing unit that executes a voice recognition process on a user utterance is provided, and the voice processing unit includes: a sound source direction/voice section designation unit that designates a sound source direction and a voice section of the user utterance; and a voice recognition unit that executes a voice recognition process targeting voice data in the sound source direction and the voice section designated by the sound source direction/voice section designation unit. The sound source direction/voice section designation unit and the voice recognition unit execute a designation process for the sound source direction and the voice section and the voice recognition process on the user utterance on condition that it is determined that a user who has executed the user utterance is looking at a predetermined specified area.

With these configurations, a highly accurate voice recognition process based on sound source direction and voice section analysis to which an image and a voice are applied is implemented.

Note that the effects described in the present description merely serve as examples and not construed to be restricted. There may be an additional effect as well.

### BRIEF DESCRIPTION OF DRAWINGS

FIG. 1 is a diagram explaining an example of an information processing apparatus that performs a response and a process based on a user utterance.

FIG. 2 is a diagram explaining a configuration example and a usage example of the information processing apparatus.

FIG. 3 is a diagram explaining a specific configuration example of the information processing apparatus.

FIG. 4 is a diagram explaining a configuration example of the information processing apparatus.

FIG. 5 is a diagram explaining a configuration example of an image processing unit and a voice processing unit of the information processing apparatus.

FIG. 6 is a diagram explaining a sound source direction estimation process based on a voice.

FIG. 7 is a diagram explaining a sound source direction estimation process based on a voice.

FIG. 8 is a diagram illustrating a flowchart explaining a sequence of a voice recognition process using a voice.

FIG. 9 is a diagram illustrating a flowchart explaining a sequence of a sound source direction and voice section detection process using an image and a voice.

FIG. 10 is a diagram explaining a specific example of display information on the information processing apparatus.

FIG. 11 is a diagram explaining a specific example of display information on the information processing apparatus.

FIG. 12 is a diagram explaining a specific example of display information on the information processing apparatus.

FIG. 13 is a diagram illustrating a flowchart explaining a sequence of a sound source direction and voice section detection process using an image and a voice.

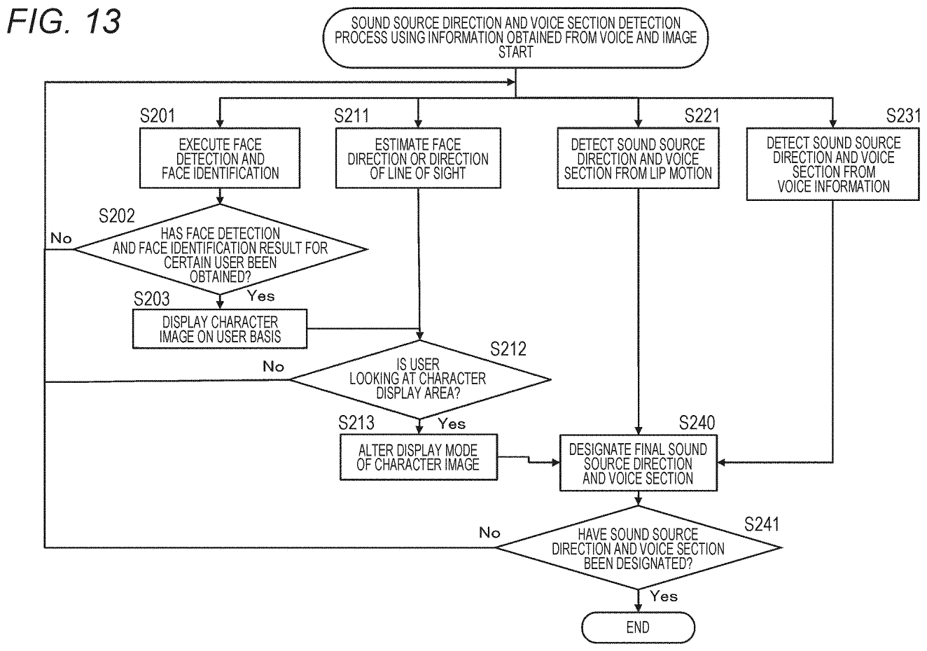

FIG. 14 is a diagram explaining an example of a voice section detection process using an image and a voice.

FIG. 15 is a diagram explaining an example of a sound source direction estimation process using an image and a voice.

FIG. 16 is a diagram explaining a specific example of display information on the information processing apparatus.

FIG. 17 is a diagram explaining a specific example of display information on the information processing apparatus.

FIG. 18 is a diagram explaining configuration examples of an information processing system.

FIG. 19 is a diagram explaining a hardware configuration example of the information processing apparatus.

### MODE FOR CARRYING OUT THE INVENTION

Hereinafter, details of an information processing apparatus, an information processing system, an information processing method, and a program of the present disclosure will be described with reference to the drawings. Note that the explanation will be made in accordance with the following items.

1. About Outline of Process executed by Information Processing Apparatus

2. About Configuration Example of Information Processing Apparatus

3. About Detailed Configurations and Processes of Image Processing Unit and Voice Processing Unit

4. About Sound Source Direction and Voice Section Designation Processing Sequence to which Image Information and Voice Information are applied

5. About Example of Process using Information on Each of Sound Source Direction and Voice Section obtained from Both of Voice and Image

6. About Example of Process in Environment where there is Plurality of Utterers around Information Processing Apparatus

7. About Configuration Example of Information Processing Apparatus and Information Processing System

8. About Hardware Configuration Example of Information Processing Apparatus

9. Summary of Configuration of Present Disclosure

### 1. About Outline of Process Executed by Information Processing Apparatus

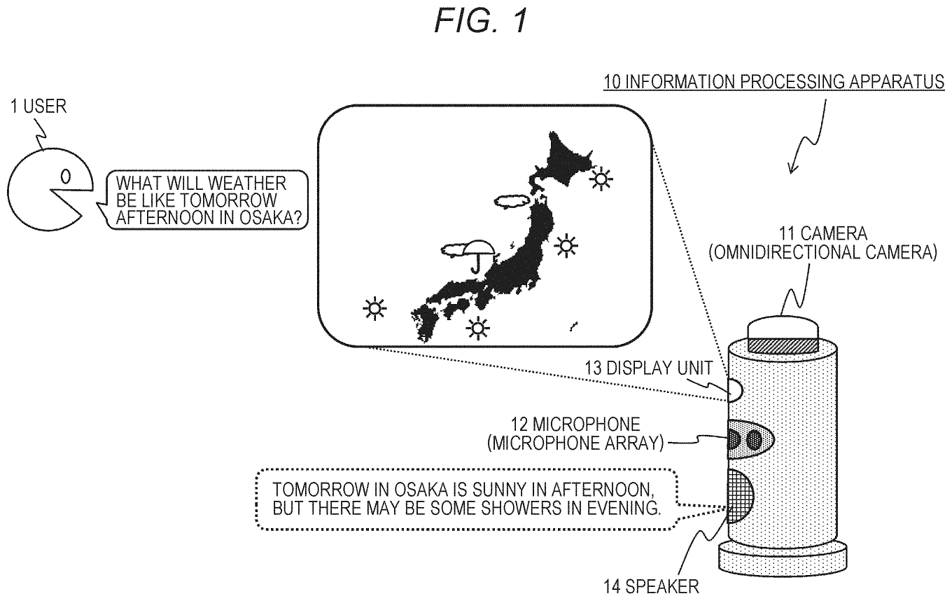

First, an outline of a process executed by an information processing apparatus of the present disclosure will be described with reference to FIG. 1 and the following drawings.

FIG. 1 is a diagram illustrating a processing example of an information processing apparatus 10 that recognizes a user utterance made by an utterer 1 and makes a response.

The information processing apparatus 10 uses a user utterance of the utterer 1, for example,

User utterance=“What will the weather be like tomorrow afternoon in Osaka?”

to execute a voice recognition process for this user utterance.

Moreover, the information processing apparatus 10 executes a process based on the voice recognition result for the user utterance.

In the example illustrated in FIG. 1, data for responding to the user utterance=“What will the weather be like tomorrow afternoon in Osaka?” is acquired, and a response is generated on the basis of the acquired data such that the generated response is output via a speaker 14.

In the example illustrated in FIG. 1, the information processing apparatus 10 displays an image indicating weather information and makes the following system response.

System response=“Tomorrow in Osaka is sunny in the afternoon, but there may be some showers in the evening.”

The information processing apparatus 10 executes a voice synthesis process (text to speech (TTS)) to generate and output the above system response.

The information processing apparatus 10 generates and outputs a response using knowledge data acquired from a storage unit in the apparatus or knowledge data acquired via a network.

The information processing apparatus 10 illustrated in FIG. 1 includes a camera 11, a microphone 12, a display unit 13, and the speaker 14, and has a configuration capable of performing voice input and output and image input and output.

The camera 11 is, for example, an omnidirectional camera capable of capturing an image of approximately 360° around. Furthermore, the microphone 12 is configured as a microphone array constituted by a plurality of microphones so as to be capable of specifying a sound source direction.

In the example illustrated in FIG. 1, an example of the display unit 13 using a projector type display unit is indicated. However, the display unit 13 may be a display type display unit, or may be configured to output display information to a display unit of a television (TV) or a personal computer (PC) or the like connected to the information processing apparatus 19.

The information processing apparatus 10 illustrated in FIG. 1 is called, for example, a smart speaker or an agent device.

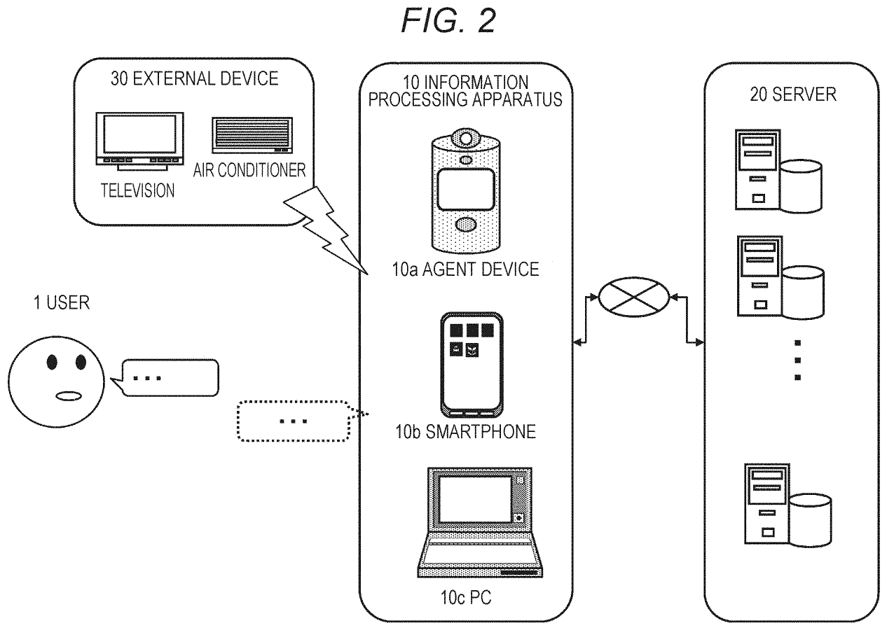

As illustrated in FIG. 2, the information processing apparatus 10 of the present disclosure is not limited to an agent device 10a, and can adopt a variety of apparatus forms such as a smartphone 10b, a PC 10c, or the like, or a signage device installed in a public place.

Besides recognizing the utterance of the utterer 1 and making a response based on the user utterance, for example, the information processing apparatus 10 also executes control on an external device 30 such as a television or an air conditioner illustrated in FIG. 2 according to the user utterance.

For example, in a case where the user utterance is a request such as “Change the channel of the television to one” or “Set the temperature of the air conditioner to 20 degrees”, the information processing apparatus 10 outputs a control signal (Wi-Fi, infrared light, or the like) to the external device 30 on the basis of the voice recognition result for this user utterance to execute control in accordance with the user utterance.

Note that the information processing apparatus 10 can be connected to a server 20 via a network so as to be able to acquire information necessary for generating a response to a user utterance from the server 20. Furthermore, a configuration that causes the server to perform the voice recognition process and a semantic analysis process may be adopted.

### 2. About Configuration Example of Information Processing Apparatus

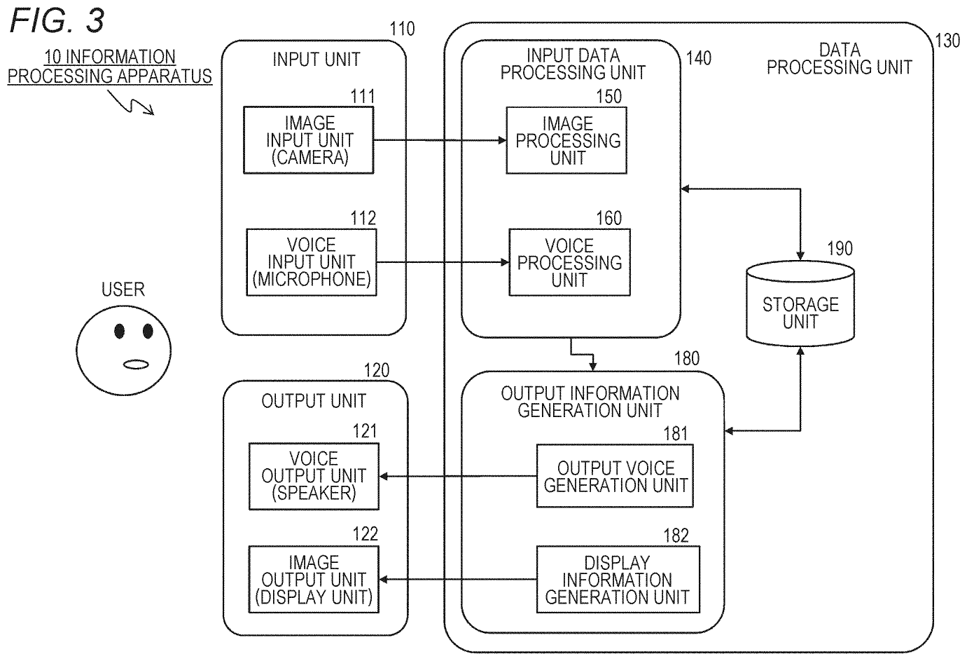

Next, a specific configuration example of the information processing apparatus will be described with reference to FIG. 3.

FIG. 3 is a diagram illustrating an example of the configuration of the information processing apparatus 10 that recognizes a user utterance to perform a process and make a response corresponding to the user utterance.

As illustrated in FIG. 3, the information processing apparatus 10 includes an input unit 110, an output unit 120, and a data processing unit 130.

Note that the data processing unit 130 can be configured in the information processing apparatus 10, but may not be configured in the information processing apparatus 10 such that a data processing unit of an external server is used. In the case of the configuration using the server, the information processing apparatus 10 transmits input data input from the input unit 110 to the server via a network, and receives the processing result of the data processing unit 130 of the server to make an output via the output unit 120.

Next, the components of the information processing apparatus 10 illustrated in FIG. 3 will be described.

The input unit 110 includes an image input unit (camera) 111 and a voice input unit (microphone) 112.

The output unit 120 includes a voice output unit (speaker) 121 and an image output unit (display unit) 122.

The information processing apparatus 10 includes these components at minimal.

The image input unit (camera) 111 corresponds to the camera 11 of the information processing apparatus 10 illustrated in FIG. 1. For example, an omnidirectional camera capable of capturing an image of approximately 360° around is adopted.

The voice input unit (microphone) 112 corresponds to the microphone 12 of the information processing apparatus 10 illustrated in FIG. 1. The voice input unit (microphone) 112 is configured as a microphone array constituted by a plurality of microphones so as to be capable of specifying a sound source direction.

The voice output unit (speaker) 121 corresponds to the speaker 14 of the information processing apparatus 10 illustrated in FIG. 1.

The image output unit (display unit) 122 corresponds to the display unit 13 of the information processing apparatus 10 illustrated in FIG. 1. For example, configuration by a projector or the like is feasible, and furthermore, a configuration using a display unit of a television as an external apparatus is also feasible.

The data processing unit 130 is configured in either the information processing apparatus 10 or a server capable of communicating with the information processing apparatus 10 as described earlier.

The data processing unit 130 includes an input data processing unit 140, an output information generation unit 180, and a storage unit 190.

The input data processing unit 140 includes an image processing unit 150 and a voice processing unit 160.

The output information generation unit 180 includes an output voice generation unit 181 and a display information generation unit 182.

A voice uttered by the user is input to the voice input unit 112 such as a microphone.

The voice input unit (microphone) 112 inputs the input voice of the user utterance to the voice processing unit 160.

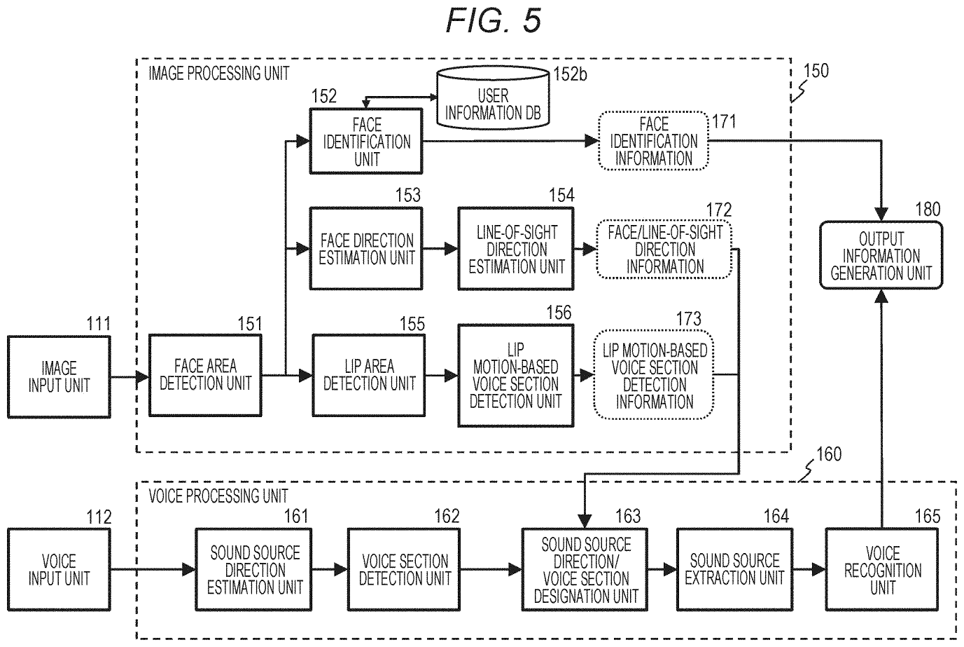

Note that the configurations and processes of the image processing unit 150 and the voice processing unit 160 will be described in detail in the later part with reference to FIG. 5 and the following drawings, and thus are described here in a simplified manner.

The voice processing unit 160 has, for example, an automatic speech recognition (ASR) function, and converts voice data into text data constituted by a plurality of words.

Moreover, an utterance semantic analysis process is executed on the text data.

The voice processing unit 160 has, for example, a natural language understanding function such as natural language understanding (NLU), and estimates the intention of the user utterance (intent), and entity information (entity), which is a meaningful element (significant element) included in the utterance, from the text data.

A specific example will be described. For example, it is assumed that the following user utterance is input.

User utterance=What will the weather be like in Osaka tomorrow afternoon?

In regard to this user utterance,

the intention (intent) is to know the weather, and

the entity information (entity) includes these words of Osaka, tomorrow, and afternoon.

If the intention (intent) and the entity information (entity) can be precisely estimated and acquired from the user utterance, the information processing apparatus 10 can perform a precise process for the user utterance.

For example, in the above example, the tomorrow's weather in Osaka in the afternoon can be acquired and output as a response.

User utterance analysis information acquired by the voice processing unit 160 is saved in the storage unit 190, and also output to the output information generation unit 180.

The image input unit 111 captures images of an uttering user and surroundings of the uttering user, and inputs the captured images to the image processing unit 150.

The image processing unit 150 analyzes the facial expression of the uttering user, the user's behavior and line-of-sight information, ambient information on the uttering user, and the like, and saves the result of this analysis in the storage unit 190, while outputting the result to the output information generation unit 180.

Note that, as described earlier, the detailed configurations and processes of the image processing unit 150 and the voice processing unit 160 will be described in the later part with reference to FIG. 5 and the following drawings.

In the storage unit 190, the contents of the user utterance, learning data based on the user utterance, display data to be output to the image output unit (display unit) 122, and the like are saved.

The output information generation unit 180 includes the output voice generation unit 181 and the display information generation unit 182.

The output voice generation unit 181 generates a system utterance for the user on the basis of the user utterance analysis information, which is the analysis result of the voice processing unit 160.

Response voice information generated by the output voice generation unit 181 is output via the voice output unit 121 such as a speaker.

The display information generation unit 182 displays text information regarding the system utterance to the user and other presentation information.

For example, in a case where the user makes a user utterance of “Show me the world map”, the world map is displayed.

The world map can be acquired from, for example, a service providing server.

Note that the information processing apparatus 10 also has a process execution function for a user utterance.

For example, in a case where utterances such as

User utterance=Play music

User utterance=Show me an interesting video are made, the information processing apparatus 10 performs processes for the user utterances, that is, a music reproduction process and a video reproduction process.

Although not illustrated in FIG. 3, the information processing apparatus 10 also has such a variety of process execution functions.

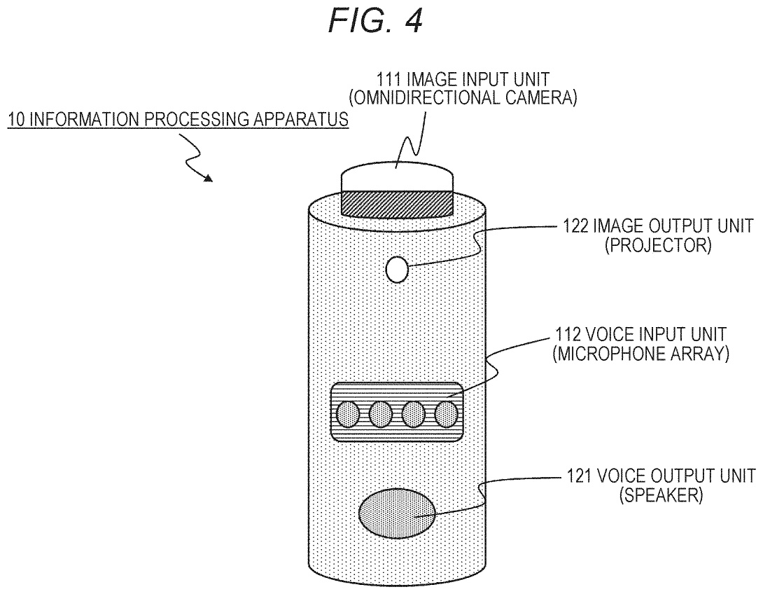

FIG. 4 is a diagram illustrating an example of the external appearance configuration of the information processing apparatus 10.

The image input unit (camera) 111 is an omnidirectional camera capable of capturing an image of approximately 360° around.

The voice input unit (microphone) 112 is configured as a microphone array constituted by a plurality of microphones so as to be capable of specifying a sound source direction.

The voice output unit (speaker) 121 is constituted by a speaker.

The image output unit (display unit) 122 is, for example, a projector image projecting unit. However, this is an example, and a configuration in which a display unit such as a liquid crystal display (LCD) is set in the information processing apparatus 10, or a configuration in which image display is performed using a display unit of an external television may be adopted.

### 3. About Detailed Configurations and Processes of Image Processing Unit and Voice Processing Unit

Next, the detailed configurations and processes of the image processing unit 150 and the voice processing unit 160 will be described with reference to FIG. 5 and the following drawings.

The information processing apparatus 10 of the present disclosure has a configuration appropriately using a variety of recognition results obtained from an image to enable voice recognition under conditions in which handling is difficult in a case where only the voice is used.

For example, specific examples (types) of information obtained from the voice and information obtained from the image are as follows.

(A) Information obtained from the voice

(a1) Voice section information (information made up of the start time and the end time of a voice section)

(a2) Sound source direction estimation information

(V) Information obtained from the image

(v1) Face area information

(v2) Face identification information

(v3) Face direction estimation information

(v4) Line-of-sight direction estimation information

(v5) Voice section detection information by lip motion

The image processing unit 150 and the voice processing unit 160 detect these types of information and use the detected information to perform high-accuracy voice recognition.

FIG. 5 is a block diagram illustrating detailed configurations of the image processing unit 150 and the voice processing unit 160.

The image processing unit 150 illustrated in FIG. 5 accepts an input of a camera-captured image from the image input unit 111. Note that the input image is a moving image.

Furthermore, the voice processing unit 160 illustrated in FIG. 5 accepts an input of voice information from the voice input unit 112.

Note that, as described earlier, the voice input unit 112 is a microphone array constituted by a plurality of microphones capable of specifying the sound source direction. The voice input unit 112 inputs a microphone-acquired sound from each microphone constituting the microphone array.

The acquired sound of the voice input unit 112 of the voice processing unit 160 includes acquired sounds of a plurality of microphones arranged at a plurality of different positions. A sound source direction estimation unit 161 estimates the sound source direction on the basis of these acquired sounds of the plurality of microphones.

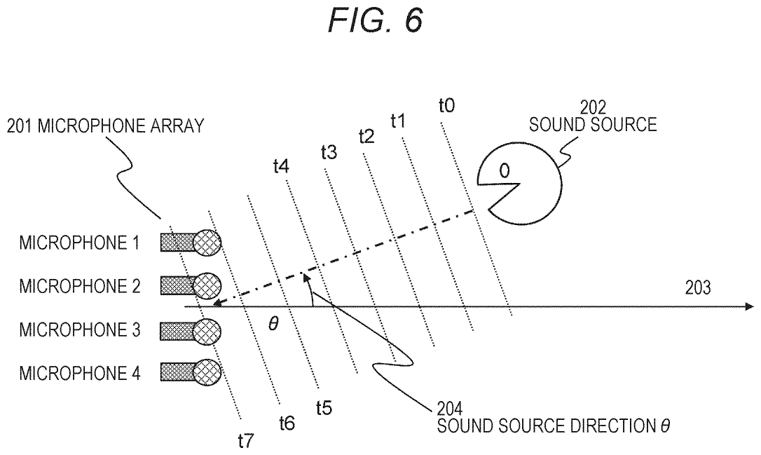

A sound source direction estimation process will be described with reference to FIG. 6.

For example, as illustrated in FIG. 6, a microphone array 201 made up of a plurality of microphones 1 to 4 arranged at different positions acquires a sound from a sound source 202 located in a specified direction. The arrival times of the sound from the sound source 202 to the respective microphones of the microphone array 201 are slightly shifted from each other. In the example illustrated in FIG. 6, a sound that arrives at the microphone 1 at time t6 arrives at the microphone 4 at time t7.

In this manner, each microphone acquires a sound signal having a phase difference according to the sound source direction. This phase difference varies according to the sound source direction, and the sound source direction can be worked out by analyzing the phase differences of the voice signals acquired by the respective microphones.

Note that, in the present embodiment, it is assumed that the sound source direction is indicated by an angle θ formed with a vertical line 203 with respect to the microphone placement direction of the microphone array as illustrated in FIG. 6. That is, the angle θ with respect to the vertical direction line 203 illustrated in FIG. 6 is assumed as a sound source direction θ 204.

In this manner, the sound source direction estimation unit 161 of the voice processing unit 160 estimates the sound source direction on the basis of the acquired sounds of the plurality of microphones arranged at the plurality of different positions, which are input via the voice input unit 112 configured to input the sound from the microphone array.

A voice section detection unit 162 of the voice processing unit 160 illustrated in FIG. 5 determines a start time and an end time of a voice from the specified sound source direction estimated by the sound source direction estimation unit 161.

During this process, a process is performed in which a delay according to the phase difference is given to each of input sounds from the specified sound source direction acquired by the plurality of microphones constituting the microphone array and having the phase differences, and respective observation signals are summed by aligning the phases of the acquired sounds of the respective microphone.

An object sound enhancement process is executed by this process. That is, by this observation signal summing process, only a sound in the specified sound source direction is enhanced, and the sound level of the other ambient environmental sounds can be reduced.

The voice section detection unit 162 uses the added signal of the observation signals of the plurality of microphones in this manner to perform a voice section determination process in which the rising position of the voice level is determined as a voice section start time and the falling position of the voice level is regarded as a voice section end time.

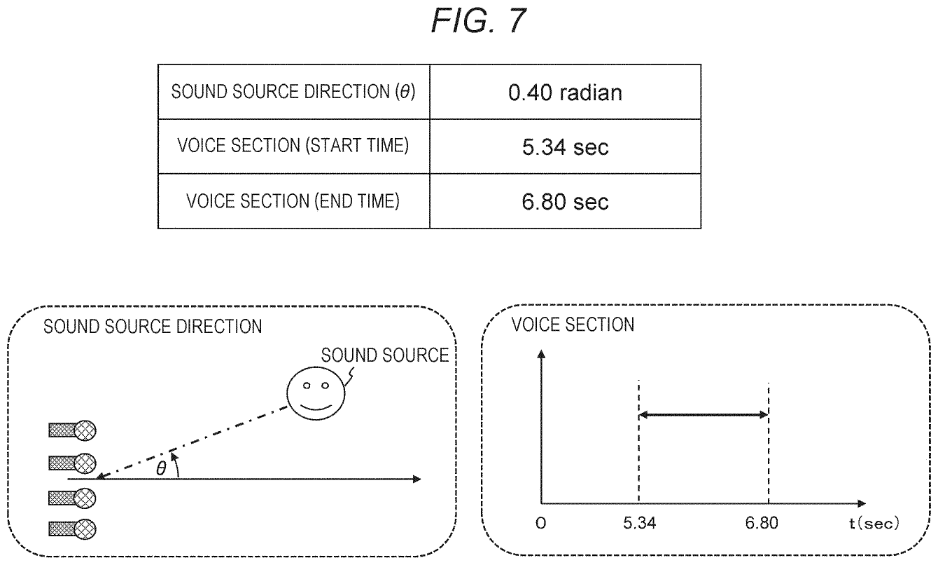

By these processes of the sound source direction estimation unit 161 and the voice section detection unit 162 of the voice processing unit 160, for example, analysis data as illustrated in FIG. 7 can be acquired.

The analysis data illustrated in FIG. 7 is as follows.

Sound source direction=0.40 radian

Voice section (start time)=5.34 sec

Voice section (end time)=6.80 sec

The sound source direction (θ) is an angle (θ) formed with the vertical line with respect to the microphone placement direction of the microphone array, as described with reference to FIG. 6.

The voice section is information indicating the start time and the end time of the utterance section of a voice from the sound source direction.

In the example illustrated in FIG. 7,

a voice start time indicating the start of utterance is 5.34 sec, and

a voice end time indicating the end of utterance is 6.80 sec. Note that a setting that assumes the measurement start time as zero is adopted.

A voice recognition process using only a voice signal has been conventionally used. That is, a system that executes a voice recognition process using only the voice processing unit 160 without using the image processing unit 150 illustrated in FIG. 5 has been present in the past.

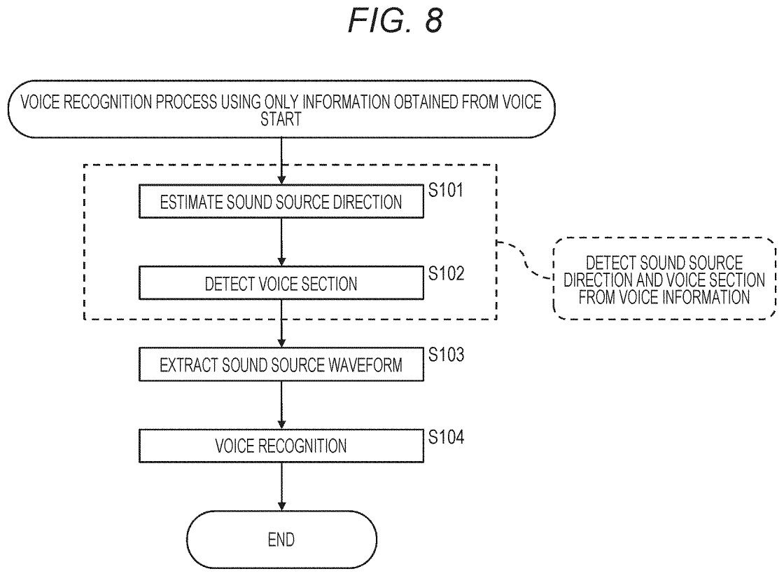

Before describing a voice recognition process using the image processing unit 150, which is one of the features in the configuration of the present disclosure, the sequence of the above general voice recognition process using only the voice processing unit 160 will be described first with reference to the flowchart illustrated FIG. 8.

First, in step S101, the sound source direction is estimated.

This process is a process executed in the sound source direction estimation unit 161 illustrated in FIG. 5, and is, for example, a process executed in accordance with the process described above with reference to FIG. 6.

Next, in step S102, the voice section is detected. This process is a process executed by the voice section detection unit 162 illustrated in FIG. 5.

As described above, the voice section detection unit 162 performs a process of giving a delay according to the phase difference to each of input sounds from the specified sound source direction acquired by the plurality of microphones constituting the microphone array and having the phase differences, and summing respective observation signals by aligning the phases of the acquired sounds of the respective microphone. By this process, the voice section determination process is performed in which an enhanced signal of the object sound is acquired, the rising position of the voice level of the enhanced signal is determined as a voice section start time, and the falling position of the voice level of the enhanced signal is regarded as a voice section end time.

Next, in step S103, a sound source waveform is extracted. This process is the process of a sound source extraction unit 164 illustrated in FIG. 5.

Note that the flow illustrated in FIG. 6 is an example of the voice recognition process using only a voice, where the process of a sound source direction/voice section designation unit 163 using an input signal from the image processing unit 150 illustrated in FIG. 3 is omitted.

In the case of the process using only the voice signal, the sound source extraction unit 164 of the voice processing unit 160 illustrated in FIG. 5 executes a sound source extraction process using only the sound source direction estimated by the sound source direction estimation unit 161 and voice section information detected by the voice section detection unit 162 of the voice processing unit 160 illustrated in FIG. 5.

The sound source extraction unit 164 executes the sound source waveform extraction process in step S103 illustrated in FIG. 8. This sound source waveform is a process of analyzing a change in frequency level or the like using, as an analysis target, a voice signal selected on the basis of the sound source direction estimated by the sound source direction estimation unit 161 and the voice section information detected by the voice section detection unit 162, which is a process that has been conventionally performed in the voice recognition process.

Next, in step S104, a voice recognition process is executed. This process is a process executed in a voice recognition unit 135 illustrated in FIG. 5.

The voice recognition unit 135 has dictionary data in which frequency change patterns in a variety of utterances registered in advance are registered. The voice recognition unit 135 uses this dictionary data to collate the frequency change pattern or the like of the acquired sound analyzed by the sound source extraction unit 164 on the basis of the acquired sound, with the dictionary data, and selects dictionary registration data with a higher degree of matching. A voice recognition unit 165 determines a term registered in the selected dictionary data as utterance contents.

Specifically, for example, as described above, the ASR function converts the voice data into text data constituted by a plurality of words. Moreover, by executing the utterance semantic analysis process on the text data, the intention (intent) of the user utterance and entity information (entity), which is a meaningful element (significant element) included in the utterance, are estimated from the text data.

The sequence in the case of performing voice recognition using only a voice acquired using the microphone is substantially given as a process in accordance with this flow illustrated in FIG. 8.

However, in the process using only a voice, there is a limit in the determination of the sound source direction and the accuracy of the voice section analysis. In particular, in a case where the level of noise (environmental sounds) other than a sound as an object is higher, the accuracy of determining the sound source direction and the voice section is deteriorated, and as a result, there is a difficulty in that a sufficient voice recognition process cannot be performed.

In order to solve such a difficulty, the configuration of the present disclosure is configured such that the image processing unit 150 is provided as illustrated in FIG. 5, and information acquired in the image processing unit 150 is output to the sound source direction/voice section designation unit 163 in the voice processing unit 160.

The sound source direction/voice section designation unit 163 performs a process of designating the sound source direction and the voice section using analysis information by the image processing unit 150, in addition to sound source direction information estimated by the sound source direction estimation unit 161 and voice section information detected by the voice section detection unit 162 of the voice processing unit 160.

As described above, in the voice recognition apparatus of the present disclosure, it is possible to determine highly accurate sound source direction and voice section by designating the sound source direction and the voice section using not only the voice but also the image analysis result, and as a result, high-accuracy voice recognition is implemented.

Hereinafter, a voice recognition process using the image processing unit 150 of the voice recognition apparatus illustrated in FIG. 5 will be described.

The image processing unit 150 in the voice recognition apparatus of the present disclosure accepts an input of the camera-captured image of the image input unit (camera) 111, and outputs the input image to a face area detection unit 151.

Note that the image input unit (camera) 111 captures a moving image, and sequentially outputs consecutive captured image frames.

The face area detection unit 151 illustrated in FIG. 5 detects a human face area from each image frame of the input image. This area detection process is a process that can be executed using an existing technology.

For example, the face area detection unit 151 holds face pattern information made up of shape data and luminance data indicating features of a face registered in advance. The face area detection unit 151 detects a face area in the image by executing a process of detecting an area similar to the registered pattern from the image area in the image frame, using this face pattern information as reference information.

Face area detection information by the face area detection unit 151 is input to a face identification unit 152, a face direction estimation unit 153, and a lip area detection unit 155 together with image information on each image frame.

The face identification unit 152 identifies whose face coincides with a face included in the face area in the image frame detected by the face area detection unit 151. The face identification unit 152 compares registered information in a user information DB 152b in which face image information on each user is saved, with captured image information to identify whose face coincides with the face in the face area in the image frame.

Face identification information 171 generated by the face identification unit 152, which indicates whose face is applicable, is output to the output information generation unit 180.

The face direction estimation unit 153 determines toward which direction the face included in the face area in the image frame detected by the face area detection unit 151 is.

The face direction estimation unit 153 determines the position of each face part such as the position of the eye and the position of the mouth from the face area detected by the face area detection unit 151, and estimates a direction toward which the face is, on the basis of the positional relationship between these face parts.

Moreover, face direction estimation information estimated by the face direction estimation unit 153 is output to a line-of-sight direction estimation unit 154.

The line-of-sight direction estimation unit 154 estimates the direction of the line of sight of the face included in the face area on the basis of the face direction estimation information estimated by the face direction estimation unit 153.

Face/line-of-sight direction information 172 made up of at least one of the face direction information estimated by the face direction estimation unit 153 or the line-of-sight direction information estimated by the line-of-sight direction estimation unit 154, or both types of the information is output to the sound source direction/voice section designation unit 163.

Note that a configuration in which the line-of-sight direction estimation unit 154 is omitted such that only the face direction information is generated and output to the sound source direction/voice section designation unit 163 may be adopted. Alternatively, a configuration in which only the line-of-sight direction information generated by the line-of-sight direction estimation unit 154 is output to the sound source direction/voice section designation unit 163 may be adopted.

The lip area detection unit 155 detects the area of the mouth, that is, a lip area in the face included in the face area in each image frame detected by the face area detection unit 151. For example, using lip shape patterns registered in a memory in advance as reference information, an area similar to the registered pattern is detected as a lip area from the face area in the image frame detected by the face area detection unit 151.

Lip area information detected by the lip area detection unit 155 is output to a lip motion-based voice section detection unit 156.

The lip motion-based voice section detection unit 156 estimates the utterance section on the basis of a movement in the lip area. That is, a time when an utterance is started (voice section start time) and a time when the utterance is ended (voice section end time) are determined on the basis of the movement of the mouth. This determination information is output to the sound source direction/voice section designation unit 163 as lip motion-based voice section detection information 173.

Note that an analysis process for the utterance section based on the lip motion is described in, for example, Patent Document 2 (Japanese Patent Application Laid-Open No. 2012-003326), and the lip motion-based voice section detection unit 156 performs, for example, the process described in this Patent Document 2 (Japanese Patent Application Laid-Open No. 2012-003326) to determine the utterance section.

### 4. About Sound Source Direction and Voice Section Designation Processing Sequence to which Image Information and Voice Information are Applied

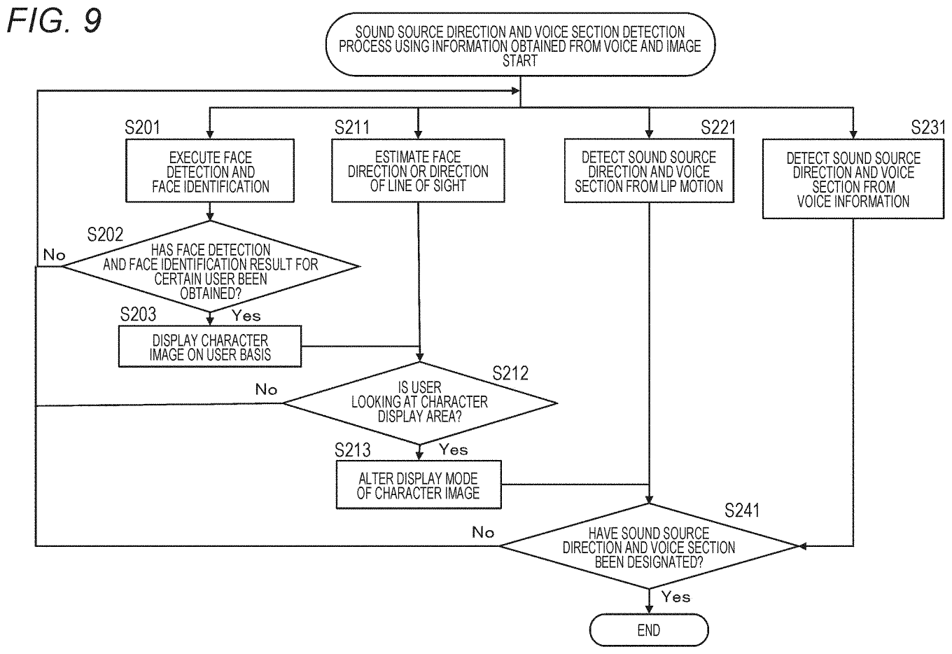

Next, a sound source direction and voice section designation processing sequence executed by the voice recognition apparatus of the present disclosure will be described with reference to the flowchart illustrated in FIG. 9.

This process illustrated in FIG. 9 is a process executed by the voice recognition apparatus including the image processing unit 150 and the voice processing unit 160 illustrated in FIG. 5.

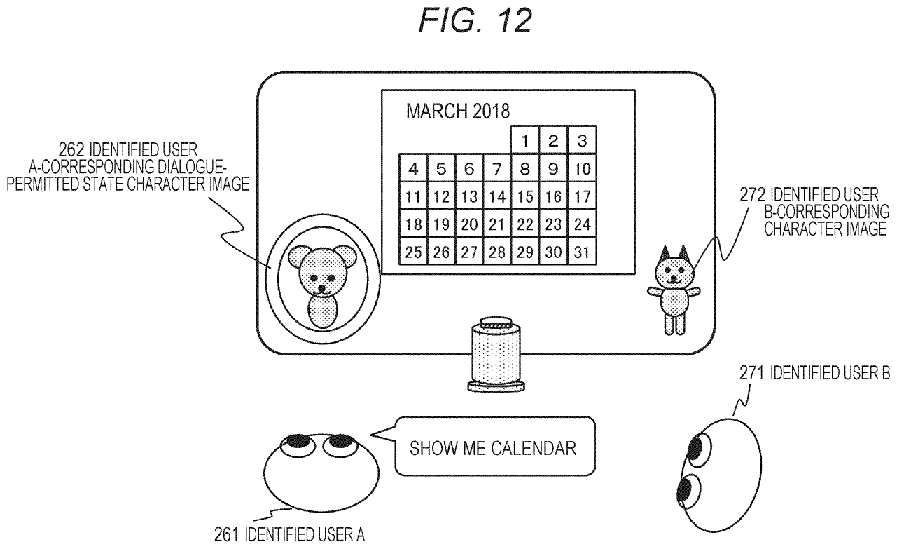

Note that this process can be executed by reading a program in which a processing sequence in accordance with the flow illustrated in FIG. 12 is recorded, from a memory under the control of a data processing unit including a central processing unit (CPU) or the like having a program execution function, for example.

A process in each step indicated in the processing flow illustrated in FIG. 9 will be sequentially described.

(Step S201)

In steps S201, S211, S221, and S231, these four processes are executed in parallel. Alternatively, the execution as a sequential process in every short time is repeated.

First, in step S201, face detection and a face identification process from a camera-captured image input from the image input unit 111 is executed.

This process is a process executed by the face area detection unit 151 and the face identification unit 152 of the image processing unit 150 illustrated in FIG. 5.

The face area detection unit 151 detects a face area in the image on the basis of the face pattern information made up of shape data and luminance data indicating features of a face registered in advance. The face identification unit 152 compares registered information in the user information DB 152b in which face image information on each user is saved, with captured image information to identify whose face coincides with the face in the face area in the image frame.

Note that, in a case where the camera-captured image input from the image input unit 111 includes a plurality of face areas, the face identification process is executed on a face area basis for this plurality of face areas.

(Step S202)

In step S202, it is determined whether or not the face detection and the face identification process from the camera-captured image in step S201 have succeeded.

In a case where the face identification process has succeeded and it has been successfully specified whose face coincides with the face in the face area included in the camera-captured image, the process proceeds to step S203.

On the other hand, in a case where the face identification process has failed and it has not been successfully specified whose face coincides with the face in the face area included in the camera-captured image, the process returns to the start.

Note that, in a case where the camera-captured image input from the image input unit 111 includes a plurality of face areas, a case where only one face is successfully identified is determined as successful.

(Step S203)

In a case where it is determined in step S202 that the face identification process has succeeded and it has been successfully specified whose face coincides with the face in the face area included in the camera-captured image, the process proceeds to step S203.

In step S203, a user-corresponding character image on a successfully specified user basis is displayed on the display unit via the image output unit 122.

This process is executed by outputting the face identification information 171, which is output information from the face identification unit 152 illustrated in FIG. 5, to the output information generation unit 180.

The display information generation unit 182 of the output information generation unit 180 displays the user-corresponding character image on a successfully specified user basis on the display unit via the image output unit 122.

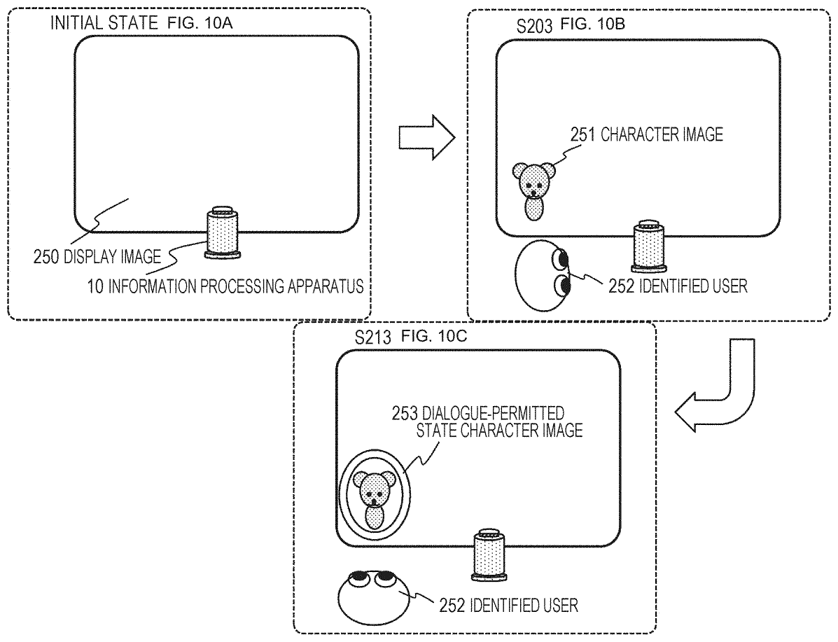

A specific image display example will be described with reference to FIG. 10. FIG. 10 illustrates a display image (projection image) 250 displayed by the image output unit 122 of the information processing apparatus 10. FIG. 10 illustrates a display image in each of the following states.

(1) Initial state

(2) Execution state of process in step S203

(3) Execution state of process in step S213

(1) In the initial state, nothing is displayed on the display image.

(2) In the execution state of the process in step S203, a character image 251 is displayed. This character image 251 is an image of a character associated with an identified user 252 identified from the camera-captured image.

This character association process can be executed by the user in advance.

Alternatively, the information processing apparatus may be configured to perform automatic association of a plurality of character images held in advance on an identified user basis and automatic registration. The registered information is held in the storage unit 190 of the information processing apparatus 10.

When the character image 251 associated with the identified user 252 illustrated in FIG. 10 is displayed in the display image, the identified user 252 can find that the identified user 252 has been detected by the information processing apparatus 10 and has been identified as to who the identified user 252 is.

Note that the character display process illustrated in FIG. 10 is performed by the control of the display information generation unit 182 of the output information generation unit 180.

(3) The image in the execution state of the process in step S213 will be described in the later part.

Note that, in the present embodiment, an example in which a character image corresponding to the user is displayed will be described; however, the display image is not limited to the character image, and can be any user-corresponding specified image that can be identified as a user-corresponding image.

(Step S211)

Next, the process in step S211 of the flow illustrated in FIG. 9 will be described.

In step S211, the face direction or the direction of the line of sight is estimated. This process is a process executed by the face direction estimation unit 153 and the line-of-sight direction estimation unit 154 of the image processing unit 150 illustrated in FIG. 5, and corresponds to a process of generating the face/line-of-sight direction information 172 illustrated in FIG. 5.

The face direction estimation unit 153 and the line-of-sight direction estimation unit 154 determine the orientation of the face on the basis of, for example, the positional relationship between face parts included in the face area, and determine the direction of the orientation of the face as the direction of the line of sight.

The face/line-of-sight direction information 172 including information on at least either the face direction or the direction of the line of sight generated by these determination processes is output to the sound source direction/voice section designation unit 163.

(Step S212)

When the estimation of the face direction or the direction of the line of sight in step S211 ends, next, in step S212, it is determined whether or not the face or the direction of the line of sight of the user is toward a character image display area that has been displayed.

In a case where the face or the direction of the line of sight of the user is toward the character image display area in the display image, the process proceeds to step S213.

On the other hand, in a case where the face or the direction of the line of sight of the user is not toward the character image display area in the display image, the process returns to the start.

(Step S213)

In step S212, in a case where the face or the direction of the line of sight of the user is toward the character image display area in the display image, the process proceeds to step S213.

In step S213, a process of altering the display mode of the character image in the display image is performed.

This process is performed by the control of the display information generation unit 182 of the output information generation unit 180.

A specific example will be described with reference to FIG. 10.

The image illustrated in FIG. 10(3) is an image corresponding to the execution state of the process in step S213.

The display image illustrated in FIG. 10(3) is an image in which the display mode of the character image 251 illustrated in FIG. 10(2) has been altered, that is, a ring is added to enclose the character image. This is an image indicating, to the identified user 252, that the dialogue between the character image and the user is enabled, and is a dialogue-permitted state character image 253.

The identified user 252 can find that the state has transitioned to a state in which the dialogue is enabled, from the fact that the display of the character image 251 illustrated in FIG. 10(2) has been altered to the dialogue-permitted state character image 253 illustrated in FIG. 10(3).

Specifically, this display alteration is executed in synchronization with the completion of the transition in the information processing apparatus 10 to a state in which the voice recognition process can be executed.

(Step S221)

Next, the process in step S221 of the flow illustrated in FIG. 9 will be described.

In step S221, a detection process for the sound source direction and the voice section based on the lip motion is performed.

This process corresponds to a process of generating the lip motion-based voice section detection information 173 executed by the lip motion-based voice section detection unit 156 of the image processing unit 150 illustrated in FIG. 5.

As described earlier, the lip motion-based voice section detection unit 156 estimates the utterance section on the basis of a movement in the lip area. That is, a time when an utterance is started (voice section start time) and a time when the utterance is ended (voice section end time) are determined on the basis of the movement of the mouth. This determination information is output to the sound source direction/voice section designation unit 163 as the lip motion-based voice section detection information 173. Furthermore, the sound source direction is designated on the basis of the orientation of the face in the face image, the position of the mouth area, and the like of the user whose lip motion has been detected. For example, the orientation of the face or the direction of the mouth is determined as the sound source direction.

(Step S231)

In step S231, a detection process for the sound source direction and the voice section based on the voice information is performed.

This process is a process executed by the sound source direction estimation unit 161 and the voice section detection unit 162 of the voice processing unit 160 illustrated in FIG. 5, and corresponds to the detection process for the sound source direction and the voice section based on only the voice, which has been described above with reference to FIGS. 6 to 8.

As described above with reference to FIG. 6, a sound from the sound source 202 is acquired by the microphone array 201 made up of the plurality of microphones 1 to 4 arranged at different positions. Each microphone acquires a sound signal having a phase difference according to the sound source direction. This phase difference varies according to the sound source direction, and the sound source direction is worked out by analyzing the phase differences of the voice signals acquired by the respective microphones.

The voice section detection unit 162 determines a start time and an end time of a voice from a specified sound source direction estimated by the sound source direction estimation unit 161. During this process, a process of aligning the phases of the acquired sounds of the plurality of microphones constituting the microphone array and summing the respective observation signals is performed. The voice section detection unit 162 uses the added signal of the observation signals of the plurality of microphones in this manner to perform the voice section determination process in which the rising position of the voice level is determined as a voice section start time and the falling position of the voice level is regarded as a voice section end time.

(Step S241)

In step S241, it is determined whether or not the sound source direction and the voice section have been designated.

This process is a process executed by the sound source direction/voice section designation unit 163 of the voice processing unit 160 illustrated in FIG. 5.

In a case where it is confirmed in step S212 that the user is looking at the character image, the sound source direction/voice section designation unit 163 executes a determination process as to whether or not the sound source direction and the voice section can be designated.

That is, only in a case where the user is looking at the character image, the designation process for the sound source direction and the voice section is performed, and thereafter the voice recognition process is executed on a voice in the designated sound source direction and voice section. In a case where the user is not looking at the character image, the designation process for the sound source direction and the voice section is not performed, and also the voice recognition process thereafter is not executed.

In a case where it is confirmed that the user is looking at the character image, the sound source direction/voice section designation unit 163 determines whether or not the sound source direction and the voice section can be designated, using these following two types of detection results: the sound source direction and voice section detection results from the lip motion in step S221, and the sound source direction and voice section detection results based on the voice in step S231.

In step S221, the sound source direction and the voice section are detected from the image information (lip motion), but there are cases where only one of the sound source direction and the voice section is successfully detected.

Similarly, also in step S231, the sound source direction and the voice section are detected from the voice information, but there are cases where only one of the sound source direction and the voice section is successfully detected.

In step S241, the sound source direction/voice section designation unit 163 combines these detection results in steps S221 and S231 to verify whether or not the sound source direction and the voice section can be designated, and makes the designation in a case where the designation is possible.

In a case where the sound source direction and the voice section are designated by combining the detection results in step S221 and S231, the process in accordance with this flow, that is, the designation process for the sound source direction and the voice section ends.

In a case where it is determined that the sound source direction and the voice section cannot be designated even by combining the detection results in steps S221 and S231, the process returns to the start and is repeated.

Particularly in a case where the sound source direction/voice section designation unit 163 has designated the sound source direction and the voice section in this step S241, the sound source extraction process in the sound source extraction unit 164 and the voice recognition process in the voice recognition unit 165 are subsequently performed.

These processes are executed as processes for a voice in the sound source direction and the voice section designated by the sound source direction/voice section designation unit 163.

The sound source extraction unit 164 is for a process of analyzing a change in frequency level or the like using, as an analysis target, a voice signal selected on the basis of the sound source direction and voice section information designated by the sound source direction/voice section designation unit 163, which is a process that has been conventionally performed in the voice recognition process.

Next, the voice recognition unit 135 uses dictionary data in which frequency change patterns of a variety of utterances registered in advance are registered, to collate the frequency change pattern or the like of the acquired sound analyzed by the sound source extraction unit 164 on the basis of the acquired sound, with the dictionary data, and selects dictionary registration data with a higher degree of matching. The voice recognition unit 165 determines a term registered in the selected dictionary data as utterance contents.

As described above, the information processing apparatus 10 of the present disclosure executes the sound source direction/voice section designation process in the sound source direction/voice section designation unit 163, and performs voice recognition on a voice in the designated sound source direction and voice section in a case where it is confirmed that the user is looking at the character image.

That is, the dialogue between the user and the information processing apparatus 10 is executed such that a dialogue between the user and the character image displayed on the display unit is performed.

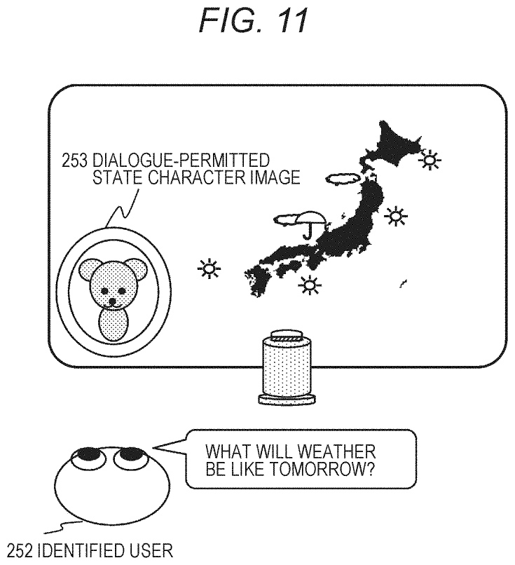

A specific example is illustrated in FIG. 11.

FIG. 11 illustrates a display image similar to the display image described above with reference to FIG. 10(3).

In the display image, the dialogue-permitted state character image 253 that the identified user 252 is looking at is displayed.

The displayed character image is a user-corresponding character image predetermined in correspondence with the identified user 252. Furthermore, while it is detected that the identified user 252 is looking at the character image, a character image set to a display mode indicating that the dialogue between the character image and the user is enabled (in the example illustrated in FIG. 11, a ring is displayed around the character) is displayed.

The identified user 252 finds that the dialogue between the character image and the user is enabled, by looking at the dialogue-permitted state character image 253, and executes an utterance. For example, the following user utterance is executed.

User utterance=“What will the weather be like tomorrow?”

The information processing apparatus 10 executes a response based on the voice recognition result for this user utterance, such as a process of displaying weather information obtained by executing a weather information providing application, and a voice output of the weather information.

Note that, as described above, the character image displayed on the display unit is a character image associated with each user in advance, and in a case where there is a plurality of registered users, respective registered users are associated with different character images.

FIG. 12 illustrates a display example in a case where there is a plurality of registered users. FIG. 12 is an example in which two users identified by the information processing apparatus 10, namely, an identified user A 261 and an identified user B 271 are located.

In this case, a character image corresponding to each user is displayed on the display unit.

In the example illustrated in FIG. 12, the identified user A is in a state of looking at a character image associated with the user A, and the identified user B is in a state of not looking at a character image associated with the user B.

In this case, the character image associated with the user A is displayed as an identified user A-corresponding dialogue-permitted state character image 262. Meanwhile, the character image associated with the user B is displayed as an identified user B-corresponding character image 272.

In this manner, since the information processing apparatus 10 of the present disclosure is configured to designate an identified user identified by the information processing apparatus 10 as the sound source direction in a case where this user is looking at the character image displayed as the display information, and execute voice recognition by narrowing down to a voice from the designated sound source direction, noise from other directions can be efficiently eliminated and high-accuracy voice recognition can be performed.

Furthermore, the user is also allowed to perform a dialogue with the information processing apparatus 10 in a manner of performing a dialogue with the character image displayed as the display information, and thus can perform a natural dialogue in a style closer to the real world.

### 5. About Example of Process Using Information on Each of Sound Source Direction and Voice Section Obtained from Both of Voice and Image

In the process described with reference to the flowchart illustrated in FIG. 9, the following process is executed in step S241.

The process of combining results of the sound source direction and voice section detection processes from the image information (lip motion) in step S221 and results of the sound source direction and voice section detection processes from the voice information in step S231 to verify whether or not the sound source direction and the voice section can be designated, and making the designation in a case where the designation is possible is performed.

In the flow illustrated in FIG. 12, a process in step S240 is executed before this process in step S241. The process in step S240 will be described.

(Step S240)

In step S240, a designation process for final sound source direction and voice section used for the voice recognition process is executed. This process is a process executed by the sound source direction/voice section designation unit 163 of the voice processing unit 160 illustrated in FIG. 5.

The sound source direction/voice section designation unit 163 executes the designation process for the sound source direction and the voice section in a case where the following conditions are satisfied.

(Condition 1) In step S212, it is confirmed that the user is looking at the character image.

(Condition 2) These following detection results: the detection results for the sound source direction and the voice section from the lip motion in step S221 and the detection results for the sound source direction and the voice section based on the voice in step S231 are input.

In a case where these two conditions are satisfied, the sound source direction/voice section designation unit 163 designates the sound source direction and the voice section, using these following two types of detection results: the sound source direction and voice section detection results from the lip motion in step S221, and the sound source direction and voice section detection results based on the voice in step S231.

In this designation process, for example, processes such as selecting either one of the two types of detection results, or employing an intermediate value or an average value of the two types of detection results, or calculating a weighted average using a predetermined weight are possible. Note that a configuration using a machine learning for this designation process may be adopted.

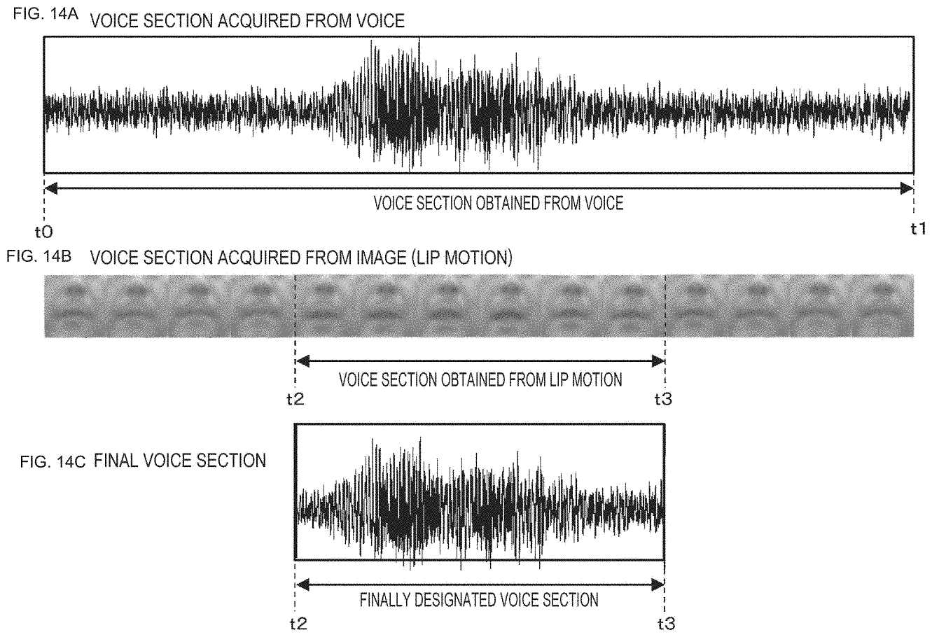

A specific example of the designation process for the final voice section executed in step S240 will be described with reference to FIG. 14.

FIG. 14 illustrates the following respective figures.

(A) Voice section acquired from voice

(B) Voice section obtained from image (lip motion)

(C) Final voice section

In the voice section obtained from the voice illustrated in FIG. 14(A), because of the influence of ambient environmental sounds (for example, the sound of the television and the sound produced by the vacuum cleaner), a voice section longer in time than the actual voice corresponding to the user utterance is extracted including the actual voice.

In contrast to this voice section obtained from the voice, the voice section obtained from the image (lip motion) illustrated in FIG. 14(B) is given as a section included in the voice section obtained from the voice and also shorter than the voice section obtained from the voice.

In such a case, shorter voice section information is selected from among the voice-based voice section detection information and the image-based voice section information, and the selected voice section information is adopted as a finally designated voice section (FIG. 14(C)).

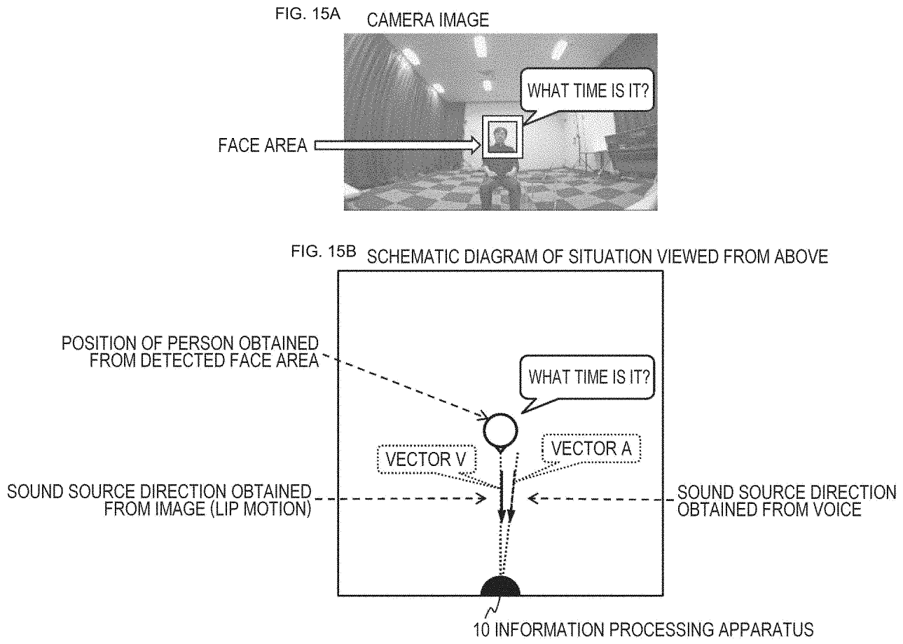

FIG. 15 is a diagram explaining a specific example of the designation process for the final sound source direction executed in step S240.

In FIG. 15, a captured image of the image input unit (camera) 111 of the information processing apparatus 10 is illustrated as FIG. 15(A).

Moreover, a diagram illustrating a positional relationship between the information processing apparatus 10 and a user who serves as a sound source as viewed from above is illustrated as FIG. 15(B).

(A) A face area is detected from the camera image, and the image processing unit 150 detects the sound source direction on the basis of the image of this face area and the lip area image.

A vector indicating the sound source direction obtained by this image analysis process is a vector V in FIG. 15(B).

Meanwhile, as described above with reference to FIG. 6, the sound source direction estimation unit 161 of the voice processing unit 160 acquires a sound from the sound source 202 using the microphone array 201 made up of the plurality of microphones 1 to 4 arranged at different positions. Each microphone acquires a sound signal having a phase difference according to the sound source direction. This phase difference varies according to the sound source direction, and the sound source direction is worked out by analyzing the phase differences of the voice signals acquired by the respective microphones.

A vector indicating the sound source direction obtained by this voice analysis process is a vector A in FIG. 15(B).

The sound source direction obtained from the voice depends on the performance of a direction estimation technology using a microphone array, and sometimes is not necessarily sufficient in terms of direction resolution and estimation performance, as compared to the sound source direction (position information) obtained from the image.

The example illustrated in FIG. 15 indicates a case where the sound source direction obtained from the voice is somewhat erroneous (shifted) in the matter of the estimation performance compared with the sound source direction (position information) obtained from the image.

In this manner, in a case where there is a difference between the sound source direction obtained from the image and the sound source direction obtained from the voice, the sound source direction obtained from the image is designated as the final sound source direction.

In a case where these following two types of detection results are input:

the sound source direction and voice section detection results from the lip motion in step S221, and

the sound source direction and voice section detection results based on the voice in step S231,

the sound source direction/voice section designation unit 163 of the voice processing unit 160 illustrated in FIG. 5

designates the final sound source direction and voice section by the processes described with reference to FIGS. 14 and 15.

Such a process is executed in step S240 of the flow illustrated in FIG. 12.

After the designation process for the final sound source direction and voice section in step S240, the process proceeds to step S241.

In step S241, it is determined whether or not the sound source direction and the voice section have been designated, and particularly in a case where the designation has been made, the sound source extraction process in the sound source extraction unit 164 and the voice recognition process in the voice recognition unit 165 are subsequently performed.

The sound source extraction unit 164 is for a process of analyzing a change in frequency level or the like using, as an analysis target, a voice signal selected on the basis of the sound source direction and voice section information designated by the sound source direction/voice section designation unit 163, which is a process that has been conventionally performed in the voice recognition process.

Next, the voice recognition unit 135 uses dictionary data in which frequency change patterns of a variety of utterances registered in advance are registered, to collate the frequency change pattern or the like of the acquired sound analyzed by the sound source extraction unit 164 on the basis of the acquired sound, with the dictionary data, and selects dictionary registration data with a higher degree of matching. The voice recognition unit 165 determines a term registered in the selected dictionary data as utterance contents.

As described above, the information processing apparatus 10 of the present disclosure executes the sound source direction/voice section designation process in the sound source direction/voice section designation unit 163, and extracts voice data corresponding to this designated information to perform voice recognition in a case where it is confirmed that the user is looking at the character image. By this process, high-accuracy voice recognition by selectively extracting a user utterance is implemented.

Moreover, the dialogue between the user and the information processing apparatus 10 is executed such that a dialogue between the user and the character image displayed on the display unit is performed.

### 6. About Example of Process in Environment where there is Plurality of Utterers Around Information Processing Apparatus

Next, an example of a process in an environment where there is a plurality of utterers around the information processing apparatus will be described.

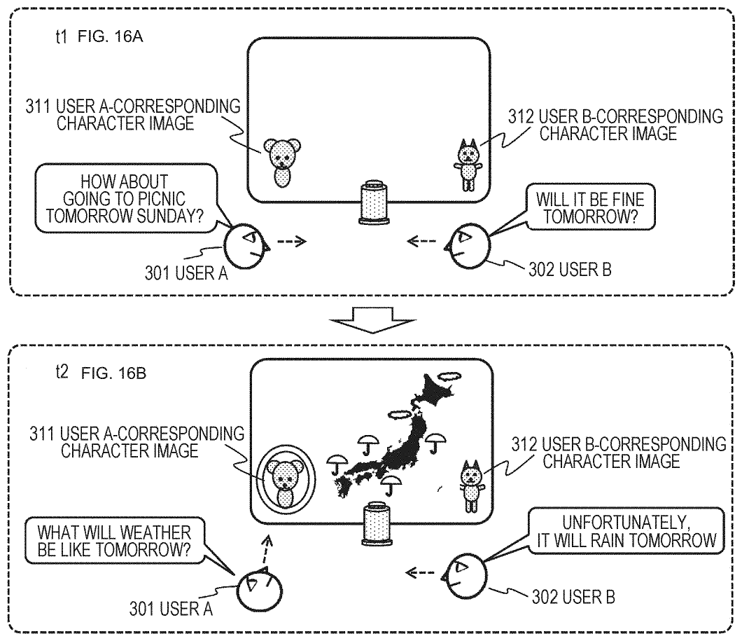

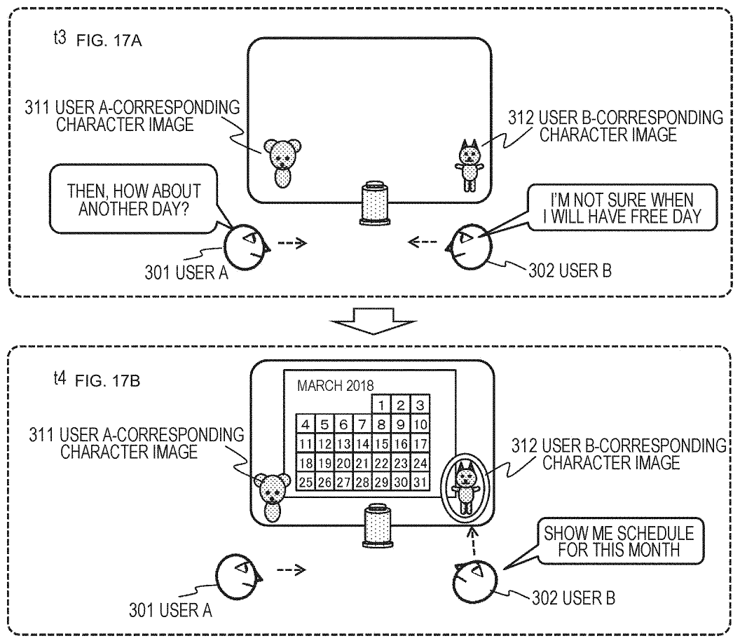

An example of a process in an environment where there is a plurality of utterers around the information processing apparatus 10 will be described with reference to FIGS. 16 and 17.

FIGS. 16 and 17 illustrate states in a time-series order from time t1 to time t4.

First, the state at time t1 in FIG. 16(1) indicates a state in which the identification of a user A 301 and a user B 302 has been executed by the process of the face identification unit 152 of the image processing unit 150 of the information processing apparatus 10, and character images corresponding to the respective users, that is, a user A-corresponding character image 311 and a user B-corresponding character image 312 are displayed on the display unit.

In this state, the user A 301 and the user B 302 have the following conversation.

Utterance from user A to user B=How about going to a picnic tomorrow Sunday?

Utterance from user B to user A=Will it be fine tomorrow?

Next, at time t2 in FIG. 16(2), the user A 301 makes the following inquiry to the user A-corresponding character image 311 displayed as the display information.

User A utterance=What will the weather be like tomorrow? The information processing apparatus 10 performs voice recognition for this user utterance, and performs a process of displaying weather forecast information on the basis of the voice recognition result.

Note that the display mode of the user A-corresponding character image 311 is altered (a surrounding circle is drawn) in response to the detection that the user A is looking at the user A-corresponding character image 311.

The user B 302 checks the displayed weather forecast information and makes the following utterance to the user A 301.

Utterance from user B to user A=Unfortunately, it will rain tomorrow, right?

Next, the state at time t3 in FIG. 17(3) is a state in which the user A 301 looks away from the user A-corresponding character image 311 to look at the user B 302 and has a conversation.

Note that the display mode of the user A-corresponding character image 311 is altered (the surrounding circle is deleted) in response to the detection that the user A is not looking at the user A-corresponding character image 311.

In this state, the user A 301 and the user B 302 have the following conversation.

Utterance from user A to user B=Then, how about another day?

Utterance from user B to user A=I'm not sure when I will have a free day

Next, at time t4 in FIG. 17(4), the user B 302 makes the following inquiry to the user B-corresponding character image 312 displayed as the display information.

User B utterance=Show me the schedule for this month

The information processing apparatus 10 performs voice recognition for this user utterance, and performs a process of displaying calendar information on the basis of the voice recognition result.

Note that the display mode of the user B-corresponding character image 312 is altered (a surrounding circle is drawn) in response to the detection that the user B is looking at the user B-corresponding character image 312.

In the states in FIGS. 16(1) and 17(3), a normal conversation is performed between the users A and B, in which case each user makes utterances without staring at the character image. In this case, the information processing apparatus 10 does not take these user utterances to be voice recognition targets.

That is, in these states, for example, the determination in step S212 of the flow in FIG. 9 is given as No, such that a state in which the sound source direction and voice section designation process is not executed, and also the voice recognition process thereafter is not executed is brought about.

On the other hand, in the states in FIGS. 16(2) and 17(4), the user makes utterances while looking at each user-corresponding character image in the screen, and in this case, the information processing apparatus 10 performs voice recognition by taking these user utterances to be voice recognition targets, and executes processes according to the results of the recognition.

In these states, for example, the determination in step S212 of the flow in FIG. 9 is given as Yes, such that these states arrive at a state in which the sound source direction and voice section designation process is executed, and the voice recognition process thereafter is executed.

As described above, the information processing apparatus of the present disclosure can perform a process by definitely distinguishing the utterance between the users and the utterance made by the user toward the information processing apparatus (=the utterance executed while looking at the character image).

Note that, in the above-described embodiments, an embodiment in which the information processing apparatus executes voice recognition particularly in a case where the user is looking at the character image area associated with the user has been described; besides the above, however, settings as follows may be adopted, for example.

(1) The information processing apparatus 10 executes voice recognition in a case where the user is looking at any area in the entire display image area.

(2) The information processing apparatus 10 executes voice recognition in a case where the user is looking at any area in the entire display area or the information processing apparatus 10.

Note that a configuration in which this setting is switched on an application basis for applications executed in the information processing apparatus 10 may be adopted, or a configuration that allows the user to freely make settings may be adopted.

### 7. About Configuration Example of Information Processing Apparatus and Information Processing System

While the process executed by the information processing apparatus 10 of the present disclosure has been described, the processing functions of each component of the information processing apparatus 10 illustrated in FIG. 3 all can be configured in one apparatus, for example, an apparatus owned by the user, such as an agent device, or a smartphone or a PC; however, it is also possible to configure a part of the processing functions to be executed in a server or the like.

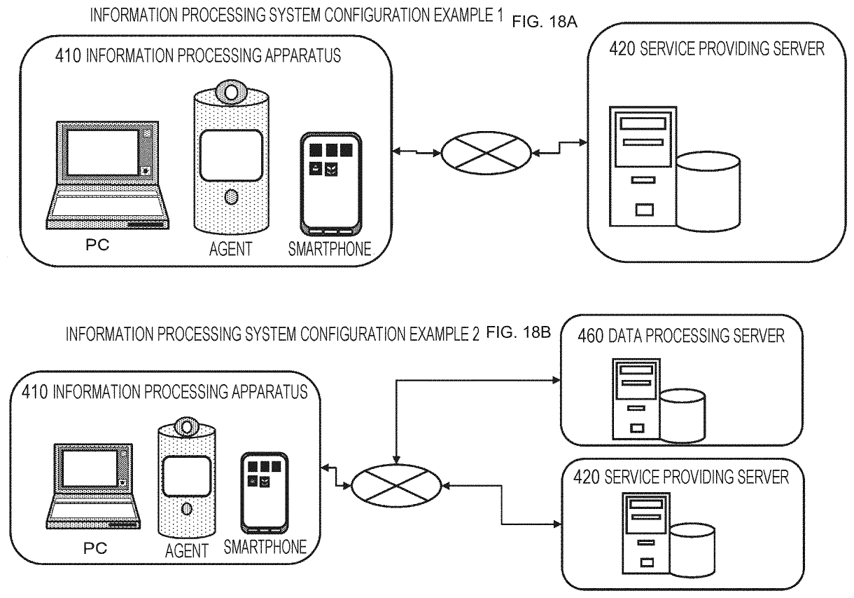

FIG. 18 illustrates system configuration examples.

An information processing system configuration example 1 in FIG. 18(1) is an example in which almost all the functions of the information processing apparatus illustrated in FIG. 3 are configured in one apparatus, for example, an information processing apparatus 410 owned by the user, which is a user terminal such as a smartphone or PC, or an agent device having voice input/output and image input/output functions.

The information processing apparatus 410 corresponding to the user terminal executes communication with a service providing server 420 only in a case where an external service is used at the time of generating a response sentence, for example.

The service providing server 420 is, for example, a music providing server, a content providing server for a movie or the like, a game server, a weather information providing server, a traffic information providing server, a medical information providing server, a sightseeing information providing server, and the like, and is constituted by a collection of servers capable of providing information necessary for executing a process or generating a response for the user utterance.

Meanwhile, an information processing system configuration example 2 in FIG. 18(2) is an example of a system in which a part of the functions of the information processing apparatus illustrated in FIG. 3 is configured in the information processing apparatus 410 owned by the user, which is a user terminal such as a smartphone or a PC, or an agent device, and another part of the functions is configured to be executed in a data processing server 460 capable of communicating with the information processing apparatus.

For example, a configuration in which only the input unit 110 and the output unit 120 in the apparatus illustrated in FIG. 3 are provided on the side of the information processing apparatus 410 on the user terminal side, and all other functions are executed on the server side is feasible.

Note that a variety of different settings are feasible for the function division mode between the user terminal-side function and the server-side function, and furthermore, a configuration in which one function is executed by both of the sides is also feasible.

### 8. About Hardware Configuration Example of Information Processing Apparatus

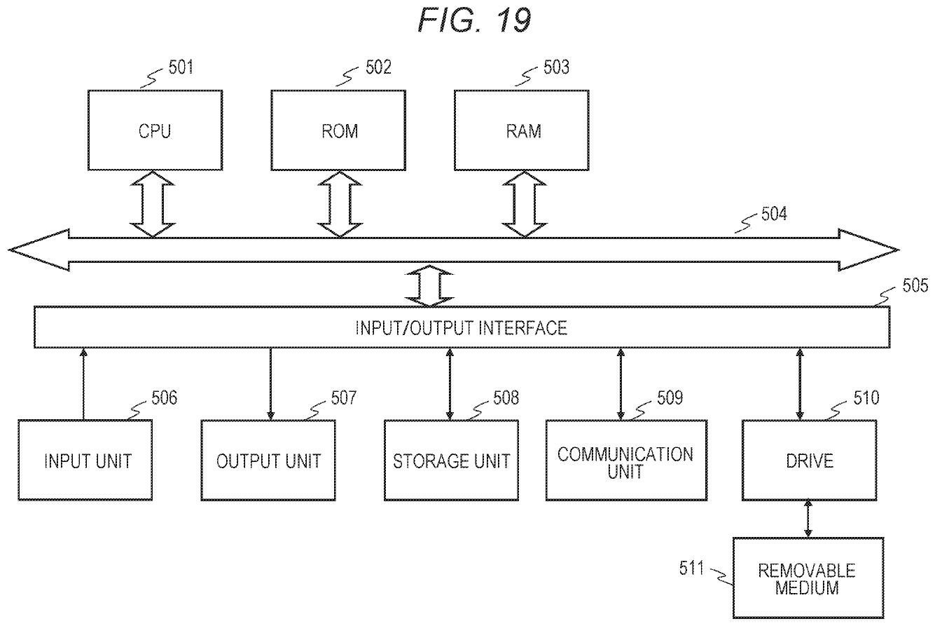

Next, a hardware configuration example of the information processing apparatus will be described with reference to FIG. 19.

The hardware described with reference to FIG. 19 is a hardware configuration example of the information processing apparatus described above with reference to FIG. 3, and furthermore, is also an example of the hardware configuration of an information processing apparatus constituting the data processing server 460 described with reference to FIG. 18.

A central processing unit (CPU) 501 functions as a control unit and a data processing unit that execute various processes in accordance with a program stored in a read only memory (ROM) 502 or a storage unit 508. For example, a process in accordance with the sequence described in the above embodiments is executed. A program, data, and the like executed by the CPU 501 are stored in a random access memory (RAM) 503. The CPU 501, the ROM 502, and the RAM 503 mentioned here are mutually connected by a bus 504.

The CPU 501 is connected to an input/output interface 505 via the bus 504, while an input unit 506 including various switches, a keyboard, a mouse, a microphone, a sensor, and the like, and an output unit 507 including a display, a speaker, and the like are connected to the input/output interface 505. The CPU 501 executes various processes in response to an instruction input from the input unit 506, and outputs a processing result, for example, to the output unit 507.

The storage unit 508 connected to the input/output interface 505 includes, for example, a hard disk and the like, and stores a program and various types of data executed by the CPU 501. A communication unit 509 functions as a transmission/reception unit for Wi-Fi communication, Bluetooth (registered trademark) (BT) communication, and other data communication via a network such as the Internet or a local area network, and communicates with an apparatus on the outside.

A drive 510 connected to the input/output interface 505 drives a removable medium 511 such as a magnetic disk, an optical disc, or a magneto-optical disk, alternatively, a semiconductor memory such as a memory card, and executes data recording or reading.

### 9. Summary of Configuration of Present Disclosure

The embodiments of the present disclosure have been minutely described thus far with reference to specified embodiments. However, it is self-evident that modification and substitution of the embodiments can be made by a person skilled in the art without departing from the spirit of the present disclosure. That is, the present invention has been disclosed in the form of exemplification and should not be interpreted restrictively. In order to judge the spirit of the present disclosure, the section of claims should be considered.

Note that the technology disclosed in the present description can be configured as follows.

(1) An information processing apparatus including a voice processing unit that executes a voice recognition process on a user utterance, in which

the voice processing unit includes: a sound source direction/voice section designation unit that designates a sound source direction and a voice section of the user utterance; and

a voice recognition unit that executes a voice recognition process targeting voice data in the sound source direction and the voice section designated by the sound source direction/voice section designation unit, and

the sound source direction/voice section designation unit

executes a designation process for the sound source direction and the voice section on the user utterance on condition that it is determined that a user who has executed the user utterance is looking at a predetermined specified area.

(2) The information processing apparatus according to (1), in which the voice recognition unit

executes a voice recognition process on the user utterance on condition that it is determined that a user who has executed the user utterance is looking at the specified area.

(3) The information processing apparatus according to (1) or (2), further including

an image processing unit that accepts an input of a camera-captured image and determines whether or not the user is looking at the specified area, on the basis of the input image.

(4) The information processing apparatus according to any one of (1) to (3), further including:

an image processing unit that accepts an input of a camera-captured image, and executes an identification process for a user included in the captured image, on the basis of the input image; and

a display information generation unit that displays an image corresponding to the user identified by the image processing unit, in the specified area.

(5) The information processing apparatus according to (4), in which the display information generation unit

alters a user-corresponding image displayed in the specified area, according to whether or not the user is looking at the specified area.

(6) The information processing apparatus according to any one of (1) to (5), in which the specified area

includes a character image area included in an output image of the information processing apparatus.

(7) The information processing apparatus according to (6), in which a character image displayed in the character image area includes a character image corresponding to each user.

(8) The information processing apparatus according to any one of (1) to (5), in which the specified area includes an image area of an output image of the information processing apparatus.

(9) The information processing apparatus according to any one of (1) to (5), in which the specified area

includes an apparatus area of the information processing apparatus.

(10) The information processing apparatus according to any one of (1) to (9), in which the sound source direction/voice section designation unit accepts inputs of two types of detection results, namely,

detection results for the sound source direction and the voice section based on an input voice, and

detection results for the sound source direction and the voice section based on an input image, and designates the sound source direction and the voice section of the user utterance.

(11) The information processing apparatus according to (10), in which the detection results for the sound source direction and the voice section based on the input voice include information obtained from an analysis result for a voice signal acquired by a microphone array.

(12) The information processing apparatus according to (10) or (10), in which the detection results for the sound source direction and the voice section based on the input image include information obtained from an analysis result for a face direction and a lip motion of a user included in a camera-captured image.

(13) An information processing system including a user terminal and a data processing server, in which

the user terminal includes:

a voice input unit that inputs a user utterance; and

an image input unit that inputs a user image,

the data processing server includes

a voice processing unit that executes a voice recognition process on the user utterance received from the user terminal,

the voice processing unit includes: a sound source direction/voice section designation unit that designates a sound source direction and a voice section of the user utterance; and

a voice recognition unit that executes a voice recognition process targeting voice data in the sound source direction and the voice section designated by the sound source direction/voice section designation unit, and

the sound source direction/voice section designation unit

executes a designation process for the sound source direction and the voice section on the user utterance on condition that it is determined that a user who has executed the user utterance is looking at a predetermined specified area.

(14) An information processing method executed in an information processing apparatus, the information processing method including:

executing, by a sound source direction/voice section designation unit, a sound source direction/voice section designation step of executing a process of designating a sound source direction and a voice section of a user utterance; and

executing, by a voice recognition unit, a voice recognition step of executing a voice recognition process targeting voice data in the sound source direction and the voice section designated by the sound source direction/voice section designation unit, in which

the sound source direction/voice section designation step and the voice recognition step include

steps executed on condition that it is determined that a user who has executed the user utterance is looking at a predetermined specified area.

(15) An information processing method executed in an information processing system including a user terminal and a data processing server, the information processing method including:

executing, in the user terminal:

a voice input process of inputting a user utterance; and

an image input process of inputting a user image; and

executing, in the data processing server:

a sound source direction/voice section designation step of executing, by a sound source direction/voice section designation unit, a process of designating a sound source direction and a voice section of the user utterance; and

a voice recognition step of executing, by a voice recognition unit, a voice recognition process targeting voice data in the sound source direction and the voice section designated by the sound source direction/voice section designation unit, in which

the data processing server

executes the sound source direction/voice section designation step and the voice recognition step on condition that it is determined that a user who has executed the user utterance is looking at a predetermined specified area.

(16) A program that causes an information process to be executed in an information processing apparatus, the program causing:

a sound source direction/voice section designation unit to execute a sound source direction/voice section designation step of executing a process of designating a sound source direction and a voice section of a user utterance; and

a voice recognition unit to execute a voice recognition step of executing a voice recognition process targeting voice data in the sound source direction and the voice section designated by the sound source direction/voice section designation unit,

the program causing the sound source direction/voice section designation step and the voice recognition step

to be executed on condition that it is determined that a user who has executed the user utterance is looking at a predetermined specified area.

Furthermore, a series of processes described in the description can be executed by hardware, software, or a complex configuration of both. In the case of executing the processes by software, a program recording a processing sequence can be installed on a memory within a computer incorporated in dedicated hardware and executed or the program can be installed on a general-purpose computer capable of executing various processes and executed. For example, the program can be recorded in a recording medium in advance. In addition to installation from a recording medium to a computer, the program can be received via a network such as a local area network (LAN) or the Internet and installed on a recording medium such as a built-in hard disk.

Note that the various processes described in the description are not only executed in time series in accordance with the description but also may be executed in parallel or individually according to the processing capability of an apparatus that executes the processes or according to necessity. Furthermore, in the present description, the term “system” refers to a logical group configuration of a plurality of apparatuses and is not limited to a system in which apparatuses having respective configurations are accommodated in the same housing.

### INDUSTRIAL APPLICABILITY

As described thus far, according to a configuration of an embodiment of the present disclosure, a highly accurate voice recognition process based on sound source direction and voice section analysis to which an image and a voice are applied is implemented.

Specifically, for example, a voice processing unit that executes a voice recognition process on a user utterance is provided, and the voice processing unit includes: a sound source direction/voice section designation unit that designates a sound source direction and a voice section of the user utterance; and a voice recognition unit that executes a voice recognition process targeting voice data in the sound source direction and the voice section designated by the sound source direction/voice section designation unit. The sound source direction/voice section designation unit and the voice recognition unit execute a designation process for the sound source direction and the voice section and the voice recognition process on the user utterance on condition that it is determined that a user who has executed the user utterance is looking at a predetermined specified area.

With these configurations, a highly accurate voice recognition process based on sound source direction and voice section analysis to which an image and a voice are applied is implemented.

### REFERENCE SIGNS LIST

10 Information processing apparatus
11 Camera
12 Microphone
13 Display unit
14 Speaker
20 Server
30 External device
110 Input unit
111 Voice input unit
112 Image input unit
120 Output unit
121 Voice output unit
122 Image output unit
130 Data processing unit
140 Input data analysis unit
150 Image processing unit
160 Voice processing unit
151 Face area detection unit
152 Face identification unit
153 Face direction estimation unit
154 Line-of-sight direction estimation unit
155 Lip area detection unit
161 Sound source direction estimation unit
162 Voice section detection unit
163 Sound source direction/voice section designation unit
164 Sound source extraction unit
165 Voice recognition unit
171 Face identification information
172 Face/line-of-sight direction information
173 Lip motion-based voice section detection information
180 Output information generation unit
181 Output voice generation unit
182 Display information generation unit
190 Storage unit
410 Information processing apparatus
420 Service providing server
460 Data processing server
501 CPU
502 ROM
503 RAM
504 Bus
505 Input/output interface
506 Input unit
507 Output unit
508 Storage unit
509 Communication unit
510 Drive
511 Removable medium

1. An information processing apparatus comprising a voice processing unit that executes a voice recognition process on a user utterance, wherein
the voice processing unit includes: a sound source direction/voice section designation unit that designates a sound source direction and a voice section of the user utterance; and
a voice recognition unit that executes a voice recognition process targeting voice data in the sound source direction and the voice section designated by the sound source direction/voice section designation unit, and
the sound source direction/voice section designation unit
executes a designation process for the sound source direction and the voice section on the user utterance on condition that it is determined that a user who has executed the user utterance is looking at a predetermined specified area.

2. The information processing apparatus according to claim 1, wherein the voice recognition unit
executes a voice recognition process on the user utterance on condition that it is determined that a user who has executed the user utterance is looking at the specified area.

3. The information processing apparatus according to claim 1, further comprising
an image processing unit that accepts an input of a camera-captured image and determines whether or not the user is looking at the specified area, on a basis of the input image.

4. The information processing apparatus according to claim 1, further comprising:
an image processing unit that accepts an input of a camera-captured image, and executes an identification process for a user included in the captured image, on a basis of the input image; and
a display information generation unit that displays an image corresponding to the user identified by the image processing unit, in the specified area.

5. The information processing apparatus according to claim 4, wherein the display information generation unit
alters a user-corresponding image displayed in the specified area, according to whether or not the user is looking at the specified area.

6. The information processing apparatus according to claim 1, wherein the specified area
includes a character image area included in an output image of the information processing apparatus.

7. The information processing apparatus according to claim 6, wherein a character image displayed in the character image area includes a character image corresponding to each user.

8. The information processing apparatus according to claim 1, wherein the specified area
includes an image area of an output image of the information processing apparatus.

9. The information processing apparatus according to claim 1, wherein the specified area
includes an apparatus area of the information processing apparatus.

10. The information processing apparatus according to claim 1, wherein the sound source direction/voice section designation unit accepts inputs of two types of detection results, namely,
detection results for the sound source direction and the voice section based on an input voice, and
detection results for the sound source direction and the voice section based on an input image, and designates the sound source direction and the voice section of the user utterance.

11. The information processing apparatus according to claim 10, wherein the detection results for the sound source direction and the voice section based on the input voice include information obtained from an analysis result for a voice signal acquired by a microphone array.

12. The information processing apparatus according to claim 10, wherein the detection results for the sound source direction and the voice section based on the input image include information obtained from an analysis result for a face direction and a lip motion of a user included in a camera-captured image.

13. An information processing system comprising a user terminal and a data processing server, wherein
the user terminal includes:
a voice input unit that inputs a user utterance; and
an image input unit that inputs a user image,
the data processing server includes
a voice processing unit that executes a voice recognition process on the user utterance received from the user terminal,
the voice processing unit includes: a sound source direction/voice section designation unit that designates a sound source direction and a voice section of the user utterance; and
a voice recognition unit that executes a voice recognition process targeting voice data in the sound source direction and the voice section designated by the sound source direction/voice section designation unit, and
the sound source direction/voice section designation unit
executes a designation process for the sound source direction and the voice section on the user utterance on condition that it is determined that a user who has executed the user utterance is looking at a predetermined specified area.

14. An information processing method executed in an information processing apparatus, the information processing method comprising:
executing, by a sound source direction/voice section designation unit, a sound source direction/voice section designation step of executing a process of designating a sound source direction and a voice section of a user utterance; and
executing, by a voice recognition unit, a voice recognition step of executing a voice recognition process targeting voice data in the sound source direction and the voice section designated by the sound source direction/voice section designation unit, wherein
the sound source direction/voice section designation step and the voice recognition step include
steps executed on condition that it is determined that a user who has executed the user utterance is looking at a predetermined specified area.

15. An information processing method executed in an information processing system including a user terminal and a data processing server, the information processing method comprising:
executing, in the user terminal:
a voice input process of inputting a user utterance; and
an image input process of inputting a user image; and
executing, in the data processing server:
a sound source direction/voice section designation step of executing, by a sound source direction/voice section designation unit, a process of designating a sound source direction and a voice section of the user utterance; and
a voice recognition step of executing, by a voice recognition unit, a voice recognition process targeting voice data in the sound source direction and the voice section designated by the sound source direction/voice section designation unit, wherein
the data processing server
executes the sound source direction/voice section designation step and the voice recognition step on condition that it is determined that a user who has executed the user utterance is looking at a predetermined specified area.

16. A program that causes an information process to be executed in an information processing apparatus, the program causing:
a sound source direction/voice section designation unit to execute a sound source direction/voice section designation step of executing a process of designating a sound source direction and a voice section of a user utterance; and
a voice recognition unit to execute a voice recognition step of executing a voice recognition process targeting voice data in the sound source direction and the voice section designated by the sound source direction/voice section designation unit,
the program causing the sound source direction/voice section designation step and the voice recognition step
to be executed on condition that it is determined that a user who has executed the user utterance is looking at a predetermined specified area.
